(19) United States
(12) Patent Application Publication
(10) Pub. No.: US 2004/0232767 A1
(43) Pub. Date: Nov. 25, 2004

(54) Supporting disk

(76) Inventor: Robert Handfield, St-Lucien (CA)

Correspondence Address: BROUILLETTE KOSIE PRINCE, 25th Floor, 1100 Rene-Levesque Boulevard West, Montreal, QC, H3B 5C9, CA

(21) Appl. No.: 10/837,688

(22) Filed: May 4, 2004

(30) Foreign Application Priority Data
May 21, 2003 (CA) 2,429,497

(51) Int. Cl. B62D 55/12

(52) U.S. Cl. 305/199; 305/195

(57) ABSTRACT

This invention relates to an endless traction band and its plurality of wheels that are used to propel band-laying vehicles [i.e., vehicles which use endless traction bands rather than tires to contact the terrain over which they are driven, e.g., snowmobiles, tractors, tanks, bulldozers, etc.] and, more particularly, to an improved supporting disk for use with the traction band. Each supporting disk comprises a plurality of laterally extending arms adapted to cooperate with the traction band's inner surface when circumferential misalignment occurs.

### FIELD OF THE INVENTION

This invention relates to a supporting disk used on a vehicle using a traction band, which localizes the supporting disk with respect to the traction band. This invention is particularly useful for snowmobiles.

### BACKGROUND OF THE INVENTION

The present invention relates to an endless traction band for a vehicle, and more particularly to a snowmobile and to the supporting disk used therewith. Such a traction band is designed to travel on snow or other similar surfaces on which the use of wheeled vehicle is of little help.

The endless band is flexible around a lateral axis so that it can follow the curvature imposed by its rotation around a sprocket, road wheels or guide wheels and idler wheels. Each traction band is designed to support a significant portion of the total weight of the vehicle and apply a traction force on the ground.

Among all off-road vehicles equipped with traction bands, recreational snowmobiles are unique in that they are equipped with only one traction band while essentially all other vehicles are equipped with two or more traction bands. Examples of such other vehicles are bulldozers, military tanks, snow-surfacing machines, etc.

Without excluding any other applications, traction bands for vehicles traveling at moderate or high speeds, which are essentially snowmobiles, are the prime interest of the present invention. The snowmobiles are therefore used in the present description as the main application for the traction bands and the method in accordance with the present invention, although the invention may be used in other types of tracked vehicles.

A snowmobile is often equipped with an elastomeric traction band that features an endless body made of a reinforced material, with longitudinally spaced and transversely disposed stiffeners embedded in the elastomeric material. The body typically defines a longitudinally extending central portion and a pair of lateral band portions each of which is located on one of the sides of the central portion. The traction band is positioned under the chassis of the snowmobile and supports most of the weight. A pair of front ski-like runners are provided to steer the snowmobile and support the other portion of the weight.

The body of the traction band has a ground-engaging outer side and an inner side. The inner side cooperates with a suspension system. The weight of the traction band is supported by either a pair of slide rails or a plurality of bogey wheels that are mechanically connected to the other parts of the suspension system. The suspension system is also used to support the traction band with respect to lateral movements.

The ground-engaging outer side has a tread pattern that is repeated uniformly or not over the entire length of the traction band. The tread pattern comprises a plurality of projecting ground engaging traction lugs that are configured and disposed in accordance with the purpose for which the traction band is designed. The traction lugs are used to increase the adherence of the snowmobile on snow mud, melting snow, ice or any other similar surfaces.

Further, the a pair of lateral band portions are usually separated from the central portion by a corresponding row of holes. Each row of holes generally cooperates with the teeth of the corresponding sprocket wheels and idler wheels or simply provide a support area for metal clips which lower the friction with the side rails.

In operation, the traction band is in a rotational contact with the plurality of circular wheels. Usually, the elastomeric material wears unequally on the inner and outer surfaces, and in a different way than the longitudinally spaced and transversely disposed stiffeners embedded in the elastomeric traction band body. It has been found that the embedded stiffeners deform and become damaged under the pressure coming from the rotating wheels, which often leads to increased level of noise or vibrations.

Some inventions were introduced to improve the traction band's behavior with respect to noise and vibration levels, when operating on a snowmobile. For instance, Courtemanche (U.S. Pat. No. 5,908,226) teaches about a guide wheel having an embossed rim surface. The rim surface is made from a succession of convex and concave sub-surfaces. The Courtemanche wheel is said to be designed such that the concave surfaces are redistributing the load and the pressure from the snowmobile to the area surrounding the embedded stiffeners as the guide wheels rotate. However, nothing stops the relative circumferential movement between the embossed guide wheels and the embedded stiffeners, such that with time and wear, the relative alignment of the concave sub-surfaces of the rim and the embedded stiffeners of the track is more likely to be shifted, and the promised benefits resulting from a concave sub-surface are lost.

There is a need for a supporting disk which remains synchronized with the traction band of the snowmobile and thus contributes to minimize the noise and/or vibrations levels.

There is also a need for a supporting disk that significantly reduces the damages and deformations induced to the embedded stiffeners in the traction band.

There is furthermore a need for a supporting disk which minimizes the relative circumferential movement between the supporting disk and the embedded stiffeners of the traction band.

### SUMMARY OF THE INVENTION

The objectives of the invention are to provide a supporting disk which, when assembled on a traction band for use with snowmobiles or other similar vehicles, remains localized with respect to the embedded stiffeners in the band body.

The localized supporting disk is embossed along its periphery and includes a succession of recess areas and circular areas, and comprises laterally extending arms added to at least one of the lateral surfaces of the supporting disk.

Consecutives arms usually fall at the same circumferential distance from consecutive guide lugs as the supporting disk and the traction band rotate along. When misalignment events occur, one of the arms acts as a circumferential stopper and cooperates with the corresponding or adjacent guide lugs of the traction band's inner surface.

The number and the positioning of the positioning arms on the supporting disk is in relation to the geometry of the guide lugs and depends on the pitch between consecutive stiffeners or stiffener localizations.

There is therefore provided a disk for use with a traction band comprising:

a) a peripheral surface including a plurality of periodically located concave areas;

b) two lateral surfaces located on each side of said peripheral surface;

c) laterally extending arms located on at least one of said lateral surfaces and adjacent to said peripheral surface.

There is furthermore provided a disk for use with a traction band for a snowmobile, said traction band having a band body including laterally disposed stiffeners which are periodically located along the circumference of said band body, said traction band further comprising an inner surface including a plurality of radially protruding guide lugs which are located in rows along the circumference of said traction band and which are generally laterally aligned with said stiffeners, said disk comprising:

a) a peripheral surface cooperating with said inner surface of said traction band, said peripheral surface including a plurality of periodically located recess areas;

b) two lateral surfaces located on each side of said peripheral surface;

c) laterally extending arms located on at least one of said lateral surfaces and adjacent to each of said recess area.

whereby, when in use, one of said recess areas is located on top of one of said stiffeners such that said arm adjacent to said recess area is laterally extending next to one of said radially protruding guide lugs.

Other aspects and many of the attendant advantages will be more readily appreciated as the same becomes better understood by reference to the following detailed description and considered in connection with the accompanying drawings in which like reference symbols designated like elements throughout the figures.

The features of the present invention which are believed to be novel are set forth with particularity in the appended claims.

### BRIEF DESCRIPTION OF THE FIGURES

FIG. 1 is a top view showing a traction band which is used in the present invention.

FIG. 2 is a section view taken along line 2-2 of the traction band of FIG. 1.

FIG. 3 is a lateral side view of a supporting disk assembled with the traction band of FIG. 1.

FIG. 4 is a longitudinal side view of the supporting disk shown in FIG. 3.

FIG. 5 is an isometric view of the supporting disk shown in FIG. 3 and 4.

FIG. 6 is a side view of the supporting disk shown in FIG. 5.

FIG. 7 is a section view of the supporting disk taken along line 7-7 of FIG. 6.

### DETAILED DESCRIPTION OF A PREFERRED EMBODIMENT

The present invention relates to a supporting disk assembled on a traction band for use with snowmobiles.

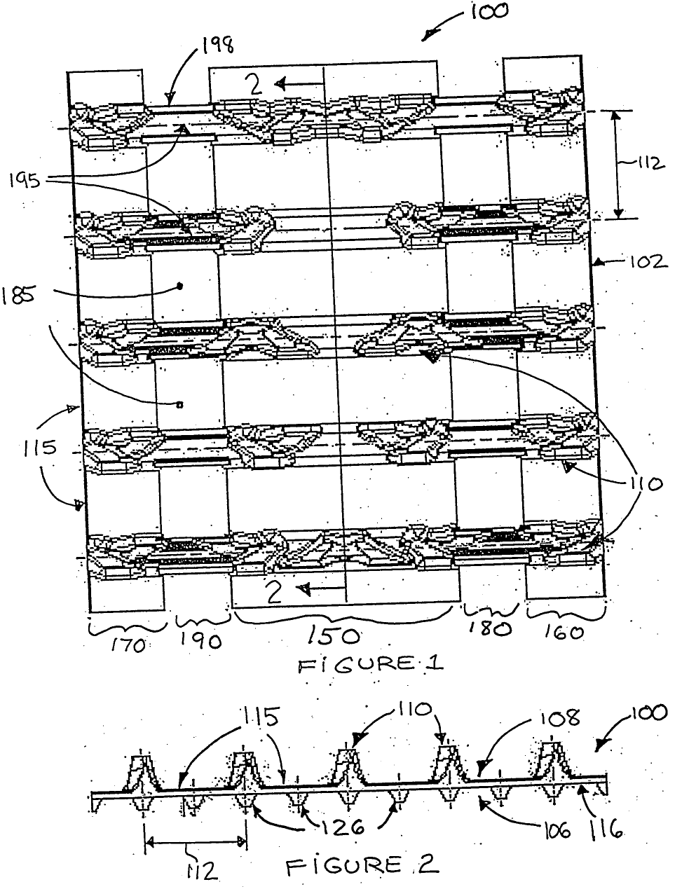

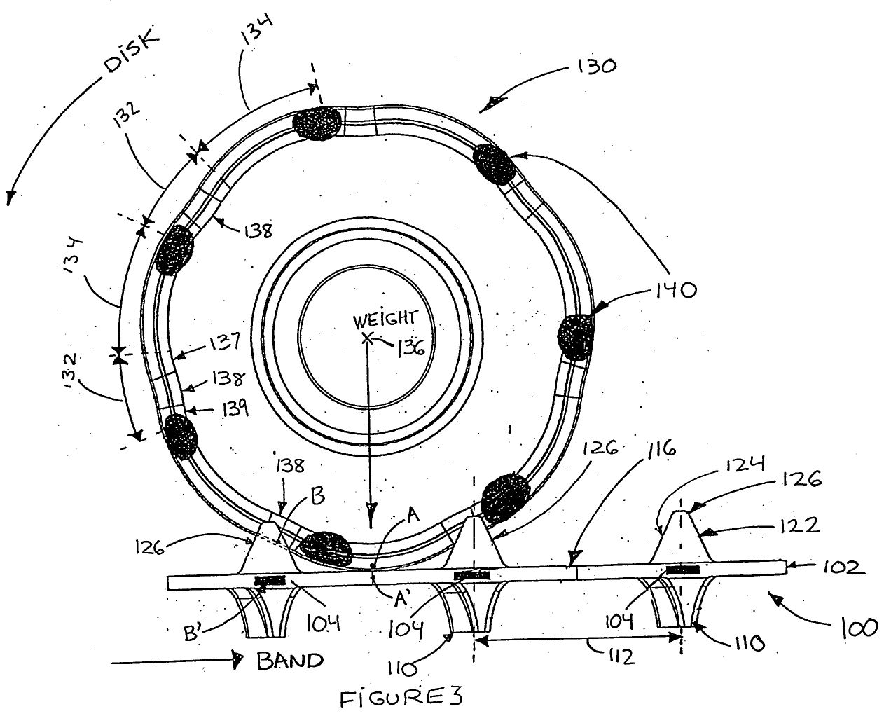

A traction band 100 made of an endless body 102 of reinforced rubber material is shown in FIGS. 1 and 2. The band 100 has longitudinally spaced and transversely disposed stiffeners (104 in FIG. 3) that may or may not be completely embedded in the rubber material of the endless body 102. The body 102 comprises a central portion 150 and two lateral band portions (160 and 170) which are located on each side of the central portion 150. The central portion 150 and the lateral band portions (160 and 170) longitudinally extend along the circumference of the endless body 102.

The body 102 of the band 100 has a ground-engaging outer side 108 comprising a selection of different lug profiles 110 which are separated from each other by a flat area 115. The lug profiles 110 and their relative arrangement with respect to one another, affect the band 100 behavior on the ground surface on which the traction band 100 rides on. The distance between two consecutive lug profiles 110 is a pitch 112 and a stiffener 104 is preferably located at every pitch 112 of lug profiles 110.

The inner side 106 offers an inner surface 116 and a plurality of guide lugs 126 which cooperate with the wheel system to provide a sliding surface and ensure power transmission to the traction band 100. The guide lugs 126 are preferably disposed in rows and at a pre-determined interval along the circumference of the traction band 100.

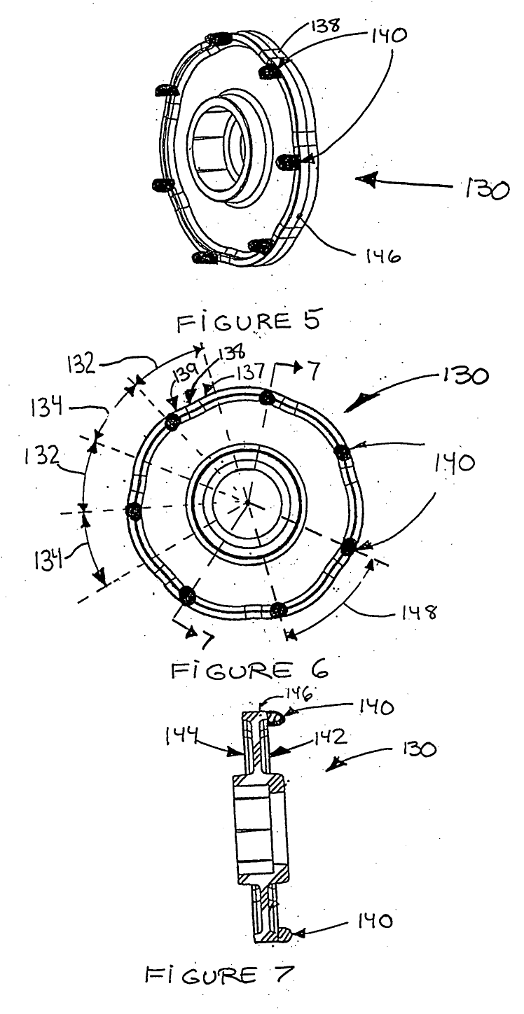

In one embodiment shown in FIG. 6, each lateral portion (160 and 170) is separated from the central portion 150 by a circumferentially extending clip-hole portion 180,190. Each clip hole portion 180,190 corresponds to a succession of holes 185 through the body 102 and are separated from each other by clip areas 195. A clip area 195 is an area of the rubber body 102, located in the clip hole portion 180, which has not been cut or molded to form a hole 185 and onto which a metal clip 198 is mounted. The holes 185 have certain size and configuration requirements to allow the insertion of the metal clips 198 and in some embodiments, to minimize the interference of the rotating toothed wheels (not shown) as they mesh with the metal clips 198 of the endless traction band 100.

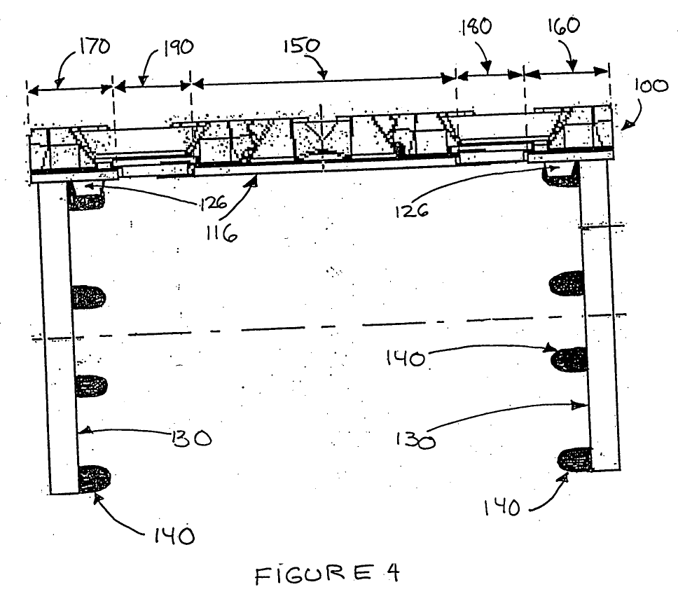

FIGS. 3 and 4 show a supporting disk 130 interacting with a traction band 100. The supporting disk 130 is different than a sprocket wheel (not shown) and it is preferably not meant to transmit power to the traction band 100, but rather to provide a stabilizing structure which rolls on the inner surface 116 of the traction band 100 and which minimizes the noise and vibration levels of the operating snowmobile.

The supporting disk 130 is embossed along its periphery and include a succession of recess or concave areas 132 and protruding or convex areas 134.

As the band 100 rotates around the plurality of wheels, the weight of the driver and the snowmobile is transferred from the supporting disks 130 to the traction band 100 in a vertical direction from the center 136 of each disk 130.

In FIG. 3, point A of the supporting disk 130 is in line with point A′ of the traction band 100, such that part of the weight of the driver and the snowmobile is transferred to the traction band 100 at point A′ in the band body 102. Point A is located on a protruding or convex area 134 of the supporting disk 130.

Moments later, as the band 100 and supporting disk 130 continue to rotate, point B of the supporting disk 130 gets closer to point B′ in the band body 102. Point B′ is located in the center of a stiffener 104 and point B is located in a recess or concave area 132 of the supporting disk 130. The recess or concave area 132 comprises a stiffener zone 138, preferably at its center, which provides more clearance between the stiffeners 104 and the supporting disk 130 when point B is in line with point B′.

Since the traction band 100 is usually made from a more elastic material than the supporting disk 130 and the embedded stiffeners 104, the traction band 100 compresses under the weight load and then takes back its original shape. However, in the vicinity of a stiffener 104 (like at point B′) the band body 102 is rigidified, has less room for deformation such that its elastomeric potential cannot be used to its fullest.

In a typical prior art supporting disk rotating along a band, the stiffeners 104 sometimes deform and become damaged under direct pressure coming from a fully circular rotating wheel, which often result in increased noise or vibration levels.

Recess or concave areas 132 diminish the weight load directly applied on the embedded stiffeners 104. When point B and B′ are in line, part of the weight of the driver and the snowmobile is therefore simultaneously distributed from the stiffener zone 138 and from the transition zones 137, 139 that are located on each side of the stiffener zone 138 to the band body 102.

However, the assembly between the traction band 100 and the snowmobile is provided by the sprocket wheel (not shown) meshing with the guide lugs 126 or with the metal clips 198 of the traction band 100. The supporting disks 130 are there to support the snowmobile and to provide stability to the snowmobile equipped with a rotating and vibrating structure like a traction band 100. They neither act as sprockets nor mesh with the traction band 100 to ensure power transmission, but are rather dragged along in rotation by friction with the traction band 100.

With time and wear, and since the band body 102 is made from an elastomeric material which will most likely partly lose a portion of its physical integrity, nothing can ensure that the supporting disk 130 will keep its circumferential alignment with the traction band, or in other words, nothing will insure that point A and point A′ or point B and point B′ remain continuously and generally vertically aligned.

In case of circumferential misalignment, all the benefits from having a recess or concave area 132 cooperating with a section of the traction band 100 comprising a stiffener 104 (like in the vicinity of point B′) are significantly compromised. Indeed, if a circumferential mismatch between B and B′ occurs such that one of the transition zone 137,139 or even worst, one of the protruding or convex areas 134, are partly on top of the stiffeners 104, the weight load will therefore be directly applied on the stiffeners 104 at one point during the respective rotation of the supporting disk 130 and the traction band 100.

With time and wear, the relative alignment of the supporting disk 130 and the traction band 100 is more likely to be shifted, especially since the band body 100 is made from an elastomeric material which may deform under sudden outside load. Also since the supporting disk 130 is usually made of a more rigid material than the band body 102, the momentary deformation and the wear of the band body 102 does not imply the same behavior from the supporting disk 130. As snowmobiles sometimes ride at high speeds and on snowy and sometimes uneven terrains, the chances of inducing misalignment between the supporting disk 130 and the traction band 100 are high.

To avoid such drawbacks, positioning arms 140 are added to the supporting disk 130. As seen in FIGS. 3, 4, 5, 6 and 7, the positioning arms 140 are located on at least one of the lateral surfaces 142,144 of the supporting disk 130 and preferably, near its circumferential surface 146 such that it can cooperate with the guide lugs 126 of the traction band 100.

Each positioning arm 140 has a generally laterally extending shape which preferably extends over the guide lugs 126 lateral width, as shown in FIG. 4. In this embodiment, the supporting disks 130 are located outward of the guide lugs 126. However, this configuration can be adapted to any localization of the guide lugs with respect to the traction band 100, as long as the positioning arms 140 extend over the width of its adjacent guide lug 126.

In this embodiment, the positioning arms 140 have a generally cylindrical shape, but could be designed differently with other shapes or to include, for instance, mating surfaces (not shown) adapted to the shape of the guide lug 126.

If more than two rows (along the circumference of the traction band 100) of guide lugs 126 are present on the inner surface 116, more supporting disks 130 can be added adjacent to the rows of guide lugs 126. In another embodiment, the supporting disks 130 have positioning arms 140 on both of their lateral surfaces 142, 144.

The positioning arms 140 are periodically located along one of the lateral surface 142,144 such that the arc length 148 between two consecutive positioning arms 140 generally and proportionally corresponds to the pitch 112 of the traction band 100. Depending on the initial orientation of the supporting disk 130 with respect to the traction band 100, each positioning arm 140 generally falls at the same circumferential distance from the guide lugs 126 as the supporting disk 130 and the traction band 100 rotate.

In one of the embodiments, the positioning arms 140 are preferably located at the junction of a protruding or convex area 134 and a recess or concave area 132 such that they can be positioned in the vicinity of the guide lugs 126 when a recess or concave area 132 is over a stiffener 104.

More generally and to ensure a proper functioning of the invention, the number and the positioning of the positioning arms 140 on the supporting disk 130 mostly relies upon the geometry of the guide lugs 126 near which each positioning arm 140 will be located and also depends on the pitch 112 between consecutive lug profiles 110.

Once the traction band 100 is installed on the snowmobile, each supporting disk 130 is positioned with respect to the traction band 100 such that the stiffener zone 138 of one recess or concave area 132 is located on top of a stiffener 104. By doing this first step, one of the positioning arms 140 is automatically positioned adjacent to one of the sides 122, 124 of the guide lugs 126. As the band 100 and the supporting disks 130 rotate, each stiffener zone 138 is positioned on top of a stiffener 104 in the band body 104 and each positioning arm 140 is positioned adjacent to a guide lug 126.

In the event that the supporting disk 130 momentarily should tend to lose its circumferential alignment with the traction band 100, the positioning arms 140 will cooperate with the guide lugs 126 to restrain any relative circumferential forward movement of the traction band 100 with respect to the supporting disk 130.

The positioning arm 140 acts as a circumferential stopper for the traction band 100 by momentarily stopping its adjacent guide lug 126 from further relative circumferential forward movement in its expected operating course with respect to the supporting disk 130.

To stop this forward movement, a portion of the positioning arm 140 is physically positioned by the rotation of the supporting disk 130 on a portion of the front side 122 of the guide lug 126, to which it is usually adjacent in a typical operating mode. At this instant, the traction band 100 locally deforms in the area of interference between the guide lug 126 and the positioning arm 140, until the positioning arm 140 pushes the supporting disk 130 back into synchronization with the stiffener areas of the traction band 100. Therefore, the supporting disk 130 catches up on the traction band 100 in their relative rotational movement such that the following positioning arm 140 falls adjacent to and not interfering with the following guide lug 126.

In another embodiment, another series of positioning arms 140 are periodically located on the supporting disk 130 such that when the stiffener zone 138 of the recess or concave area 132 is located over a stiffener 104 two positioning arms 140 are located adjacent to the front 122 and rear 124 sides of the guide lugs 126.

Although a preferred embodiment of the invention has been described in detail herein and illustrated in the accompanying figures, it is to be understood that the invention is not limited to this precise embodiment and that various changes and modifications may be effected therein without departing from the scope or spirit of the present invention.

1. A disk for use with a traction band comprising:
a) a peripheral surface including a plurality of periodically located concave areas;
b) two lateral surfaces located on each side of said peripheral surface;
c) laterally extending arms located on at least one of said lateral surfaces and adjacent to said peripheral surface.

2. A disk as claimed in claim 1, wherein said arms have the same periodicity as said concave areas.

3. A disk as claimed in claim 2, wherein consecutive concave areas are separated by convex areas.

4. A disk as claimed in claim 3, wherein said arms are located near the juncture of each said concave area to its adjacent convex area.

5. A disk as claimed in claim 4, wherein each convex area has a leading end and a trailing end and wherein said arms are located near the trailing end of each convex area.

6. A disk as claimed in claim 5, wherein each said concave area comprises a stiffener zone and transition zones located on each side of said stiffener zone.

7. A disk for use with a traction band for a snowmobile, said traction band having a band body including laterally disposed stiffeners which are periodically located along the circumference of said band body, said traction band further comprising an inner surface including a plurality of radially protruding guide lugs which are located in rows along the circumference of said traction band and which are generally laterally aligned with said stiffeners, said disk comprising:
a) a peripheral surface cooperating with said inner surface of said traction band, said peripheral surface including a plurality of periodically located recess areas;
b) two lateral surfaces located on each side of said peripheral surface;
c) laterally extending arms located on at least one of said lateral surfaces and adjacent to each of said recess area.
whereby, when in use, one of said recess areas is located on top of one of said stiffeners such that said arm adjacent to said recess area is laterally extending next to one of said radially protruding guide lugs.

8. A disk as claimed in claim 7, wherein each said recess area comprises a stiffener zone and transition zones located on each side of said stiffener zone.

9. A disk as claimed in claim 8, wherein, when in use, said stiffener zone lies on top of said stiffeners.

10. A disk as claimed in claim 8, wherein consecutive recess areas are separated by protruding areas.

11. A disk as claimed in claim 7, wherein consecutive stiffeners define a stiffener pitch and consecutive arms define an arc length which is generally equal to said stiffener pitch.

12. A disk as claimed in claim 7, wherein said arms are generally cylindrical.

13. A disk as claimed in claim 7, wherein each said arm include a mating surface and each said guide lug has a front and a rear surface, said mating surface is adapted to cooperate with said front or said rear surface of said guide lugs to maintain each said recess areas over said stiffeners.
